(19) United States
(12) Patent Application Publication
(10) Pub. No.: US 2020/0221722 A1
(43) Pub. Date: Jul. 16, 2020

(54) GRANOLA BUTTER PRODUCT AND PROCESS OF MAKING A GRANOLA BUTTER PRODUCT

(71) Applicant: Kween Foods LLC, Solana Beach, CA (US)

(72) Inventors: Alexandra Kathryn Bonar, Solana Beach, CA (US); Eric Myles Katz, Solana Beach, CA (US); Ariav Schraer, San Diego, CA (US)

(21) Appl. No.: 16/743,582

(22) Filed: Jan. 15, 2020

Related U.S. Application Data
(60) Provisional application No. 62/792,838, filed on Jan. 15, 2019.

(51) Int. Cl. A23D 7/005; A23D 7/04

(52) U.S. Cl. CPC A23D 7/0056; A23D 7/04

(57) ABSTRACT

The present disclosure provides a spreadable granola butter that is an emulsion of granola particles in an oil. The present disclosure also provides a method of making a granola butter from granola. The method includes subjecting the granola to particle size reduction to form reduced size granola particles; and emulsifying the granola in a fat to form the granola butter. The present disclosure also provides a method of providing nutrition to a human, the method including orally administering a granola butter to the human, and the granola butter is an emulsion of granola particles in an oil. In a particularly preferred embodiment, the granola butter is free of one or more common food allergens, such as gluten, milk, eggs, fish, crustacean shellfish, tree nuts, peanuts, wheat or soya.

### CROSS REFERENCE TO RELATED APPLICATION

This application claims the benefit of priority under 35 U.S.C. § 119(e)(1) of provisional patent application U.S. Ser. No. 62/792,838 filed Jan. 15, 2019, and its entire disclosure is incorporated herein by reference.

### BACKGROUND

The present disclosure relates generally to food products and processes of making a food product, in particular granola food products such as spreadable granola butter.

Granola and granola food products are widely popular food items. Granola-based food products are popular because of their delicious taste as well as the health benefits associated with granola consumption. However, the various forms in which granola is available to consumers has remained limited and relatively unchanged for decades.

The most common granola food products are granola bars. Granola bars contain granola that has been pressed and cut into dry, crumbly rectangles. Granola cereal is another popular example of a granola food product. These and other conventional forms of granola products are dry and crunchy.

A different popular food product is conventional nut-based spreads, such as peanut butter and almond butter. Nut-based spreads are a widely embraced product because of the ease of spreading the butter and also the health benefits associated with consuming the product. However, a significant portion of potential consumers have a dietary restriction or allergen sensitivity that precludes them from consuming nut-based spreads.

### SUMMARY

The inventor advantageously developed a granola butter and a process of making it that combine the health benefits of granola with the ease of consumption provided in a spreadable food product. The embodiments provided by the present disclosure solve the problem of providing a spreadable granola product to consumers with dietary restrictions and/or allergen sensitivities that preclude them from consuming nut-based spreads. Moreover, the embodiments provided by the present disclosure retain the health benefits of traditional granola products but are more conveniently consumed by the user because of a spreadable form of the product.

Accordingly, in a general embodiment, the present disclosure provides a spreadable granola butter comprising an emulsion of granola particles in an oil. The granola particles preferably comprise a cereal that has been subjected to milling, for example rolled oats that have been subjected to milling.

In an embodiment of the spreadable granola butter, at least a portion of the oil is selected from the group consisting of olive oil, coconut oil, canola oil, avocado oil, butter, grapeseed oil, palm oil, sesame oil, safflower oil, rice bran oil, rapeseed oil, oil from one or more nuts, oil from one or more legumes, and mixtures thereof.

In an embodiment of the spreadable granola butter, the spreadable granola butter has at least one characteristic selected from the group consisting of gluten-free; vegan; free of any genetically modified organisms (GMO's); and free of one or more of milk, eggs, fish, crustacean shellfish, tree nuts, peanuts, wheat or soya.

In an embodiment of the spreadable granola butter, the emulsion further comprises a sweetener selected from the group consisting of maple syrup, honey, agave, brown sugar, regular sugar, dates, date sugar, molasses, fruit syrup, and mixtures thereof.

In an embodiment of the spreadable granola butter, the granola particles are optionally coated with at least one spice, for example at least one spice selected from the group consisting of allspice, cinnamon, ginger, cardamom and mixtures thereof. Additionally or alternatively, the spreadable granola butter can optionally further comprise at least one flavor (e.g., one or more of vanilla extract, cacao, or collagen). At least a portion of the flavor can be added to the granola before and/or during emulsifying of the granola so that the flavor is substantially homogeneously dispersed in the emulsion.

The present disclosure also provides a method of making a granola butter from granola, the method comprising: subjecting the granola to particle size reduction to form reduced size granola particles; and emulsifying the granola in a fat to form the granola butter.

In an embodiment of the method, the method further comprises forming the granola before subjecting the granola to the particle size reduction, wherein the forming of the granola comprises heating a composition comprising a cereal and at least one of an oil or a sweetener. The heating of the composition comprising the cereal to form the granola is preferably performed by at least one device selected from the group consisting of a convection oven, a tunnel oven, a conveyor oven, a heated mixer, a deck oven, and a walk-in oven. The cereal preferably comprises rolled oats. The forming of the granola preferably comprises forming the composition before and/or during the heating of the composition, wherein the forming of the composition comprises mixing the cereal with at least one additional ingredient selected from the group consisting of salt, a spice, flaxseed, an oil, a sweetener and mixtures thereof. The mixing of the cereal with the at least one additional ingredient before and/or during the heating of the composition is preferably performed by at least one device selected from the group consisting of a tank mixer, a vat mixer, an agitator, a bowl mixer, and a bar mixer.

In an embodiment of the method, at least one of the particle size reduction of the granola or the emulsifying of the granola is performed in at least one machine selected from the group consisting of a blender, a vertical food processor, a hammer mill, a spice mill, an oat mill, a stone mill, a roller mill, a ball mill, a nut grinder, a vat mixer and a tumbler mixer.

In an embodiment of the method, at least a portion of the particle size reduction of the granola is performed at a different time than the emulsifying of the granola.

In an embodiment of the method, at least a portion of the particle size reduction of the granola is performed concurrently with at least a portion of the emulsifying of the granola.

The present disclosure also provides a method of providing nutrition to a human, the method comprising orally administering a granola butter to the human, the granola butter comprising an emulsion of granola particles in an oil. The human can have an allergy to at least one allergen selected from the group consisting of gluten, milk, eggs, fish, crustacean shellfish, tree nuts, peanuts, wheat, soya and combinations thereof and the at least one allergen is absent from the granola butter. The administering of the granola butter to the human can comprise spreading the granola butter on another food product.

Additional features and advantages are described herein and will be apparent from the following Figures and Detailed Description.

### BRIEF DESCRIPTION OF DRAWINGS

FIG. 1 is a flowchart of an embodiment of a process of making a granola butter.

FIG. 2 is a flowchart of an alternative embodiment of a process of making a granola butter.

FIG. 3 is a flowchart of an alternative embodiment of a process of making a granola butter.

FIG. 4 is a table generally illustrating an embodiment of an original flavor spreadable granola butter.

FIG. 5 is a table generally illustrating an embodiment of a chocolate flavor spreadable granola butter.

FIG. 6 is a table generally illustrating an embodiment of a collagen flavor spreadable granola butter.

FIG. 7 is a table generally illustrating an embodiment of a vanilla flavor spreadable granola butter.

### DETAILED DESCRIPTION

### Definitions

Some definitions are provided hereafter. Nevertheless, definitions may be located in the “Embodiments” section below, and the above header “Definitions” does not mean that such disclosures in the “Embodiments” section are not definitions.

All percentages expressed herein are by weight of the total weight of the composition unless expressed otherwise. As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. All numerical ranges herein should be understood to include all integers, whole or fractions, within the range. A range “between” two values also includes the two values. For example, “20 minutes to 200 minutes” includes 20 minutes and includes 200 minutes. Moreover, the disclosed numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in this disclosure and the appended claims, the singular forms “a,” “an” and “the” include plural referents unless the context clearly dictates otherwise. Thus, for example, reference to “an oil” or “the oil” includes one oil but also two or more oils.

The words “comprise,” “comprises” and “comprising” are to be interpreted inclusively rather than exclusively. Likewise, the terms “include,” “including” and “or” should all be construed to be inclusive, unless such a construction is clearly prohibited from the context. Nevertheless, the compositions disclosed herein may lack any element that is not specifically disclosed herein. Thus, a disclosure of an embodiment using the term “comprising” includes a disclosure of embodiments “consisting essentially of” and “consisting of” the components identified. Where used herein, the terms “example” and “such as,” particularly when followed by a listing of terms, are merely exemplary and illustrative and should not be deemed to be exclusive or comprehensive.

The term “and/or” used in the context of “X and/or Y” should be interpreted as “X,” or “Y,” or “X and Y.” Similarly, “at least one of X or Y” should be interpreted as “X,” or “Y,” or “both X and Y.” For example, “at least one sweetener or fat” means “a sweetener,” or “a fat,” or “both a sweetener and a fat.”

The terms “food,” “food product” and “food composition” are used interchangeably and mean a product or composition that is intended for oral ingestion by an individual, such as a human, and provides at least one nutrient to the individual. The food products of the present disclosure, including the many embodiments described herein, can comprise, consist of, or consist essentially of the elements disclosed herein, as well as any additional or optional ingredients, components, or elements described herein or otherwise useful in a diet.

As used herein, “fat” means any lipid, including “oils” which are lipids that are liquid at room temperature and also including lipids that are solid at room

As used herein, “administering” includes another individual providing a referenced composition to an individual so that the individual can consume the composition and also includes merely the act of the individual themselves consuming a referenced composition.

### Embodiments

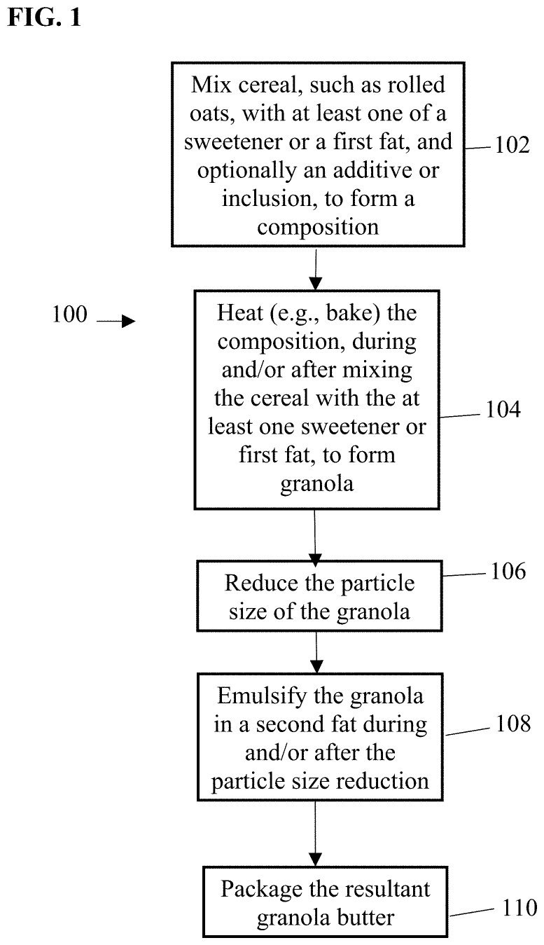

In a preferred embodiment, the granola butter disclosed herein is an oat-based spread. As shown in FIG. 1, a process 100 of making the granola butter can comprise mixing a cereal with at least one of a sweetener or a fat (Step 102). The cereal can be subjected to heating to thereby form granola (Step 104), such as by toasting, cooking and/or baking the cereal. At least a portion of the oats can be rolled oats which optionally can be gluten-free and/or organic. Additionally or alternatively to oats, one or more other cereals or pseudo-cereals can be heated to form the granola, for example one or more of quinoa, buckwheat, muesli, or rice puffed cereal.

Preferably the oats are heated in a composition further comprising a sweetener and/or a fat. At least a portion of the sweetener can be selected from the group consisting of maple syrup, honey, agave, brown sugar, regular sugar, dates, date sugar, molasses, fruit syrup, and mixtures thereof. In a particularly preferred embodiment, at least a portion of the sweetener is maple syrup.

The fat can be any edible oil. In an embodiment, at least a portion of the fat is at least one of vegetable oil or nut/seed oil. For example, at least a portion of the fat can be selected from the group consisting of olive oil, coconut oil, canola oil, avocado oil, butter, grapeseed oil, palm oil, sesame oil, safflower oil, rice bran oil, rapeseed oil, oil from one or more nuts such as almonds, oil from one or more legumes such as soybeans or peanuts, and mixtures thereof. In a particularly preferred embodiment, at least a portion of the fat is olive oil.

In an embodiment, at least a portion of the sweetener and/or at least a portion of the fat are mixed with the oats before the heating of the oats. Additionally or alternatively, at least a portion of the sweetener and/or at least a portion of the fat can be mixed with the oats during the heating of the oats.

The sweetener and/or the fat can be mixed with the oats by hand but preferably in a mixing device that employs mechanical agitation, such as one or more of a tank mixer, a vat mixer, an agitator, a bowl mixer, a bar mixer, or the like.

The heating of the oats to form the granola can be performed in one or more of a convection oven, a tunnel oven, a conveyor oven, a heated mixer, a deck oven, a walk-in oven, or the like. In an embodiment, the oats (optionally in the presence of at least a portion of the sweetener and/or at least a portion of the fat) are heated for a predetermined time period between 20 minutes and 200 minutes, preferably between 30 minutes and 150 minutes, more preferably between 50 minutes and 100 minutes, most preferably about 75 minutes, at a predetermined temperature between 150° F. and 500° F., preferably between 200° F. and 400° F., more preferably between 225° F. and 300° F., most preferably about 265° F. As disclosed above, optionally at least a portion of the sweetener and/or at least a portion of the fat can be mixed with the oats during the heating of the oats.

In an embodiment, one or more inclusions or additives can be included with the granola. Non-limiting examples of suitable inclusions or additives are salt, nuts, seeds, powders or other dry materials. Preferred inclusions or additives are salt; coconut; nuts; cacao/chocolate; egg; herbs; spices such as cinnamon, cardamom, ginger or allspice; flavorings such as vanilla extract or collagen; seeds such as flaxseed or pumpkin seed; fruit such as dried fruit; and mixtures thereof. At least a portion of the one or more inclusions or additives can be mixed with the oats before the heating of the oats. Additionally or alternatively, at least a portion of the one or more inclusions or additives can be mixed with the oats during the heating of the oats and/or after the formation of the granola by the heating.

After formation of the granola by the heating of the oats, the granola can be broken down to a reduced particle size (step 106) and can be emulsified with additional fat (Step 108) to form a granola butter which can be used as a spreadable condiment. Emulsification of the reduced particle size granola with the fat provides the granola butter disclosed herein, which to the inventor's best knowledge is the first ever granola-based wet mixture condiment. The granola butter preferably has a viscosity at room temperature (25° C.) between 100,000 cps and 275,000 cps, preferably between 150,000 cps and 250,000 cps.

The granola butter can be used as a nut butter replacement. If nuts are not included in the granola butter, as in a particularly preferred embodiment, the granola butter can be free of nuts and top eight allergens (i.e., milk, eggs, fish, crustacean shellfish, tree nuts, peanuts, wheat and soya). For example, a particularly preferred embodiment of the granola butter consists essentially of or consists of gluten-free oats, flaxseed, olive oil, coconut oil, maple syrup, salt and spices.

Optionally, at least a portion of the reducing of the particle size of the granola can be performed simultaneously with at least a portion of the emulsifying of the granola with the additional fat. Additionally or alternatively, at least a portion of the reducing of the particle size of the granola and at least a portion of the emulsifying of the granola with the additional fat can be performed sequentially.

Optionally, a flavor such as one or more of vanilla extract, cacao, or collagen can be mixed with the granola before and/or during the emulsifying of the granola. Additionally or alternatively, the flavor can be mixed with the cereal so that the flavor can be included in the granola formed by the heating of the cereal. In these embodiments, the flavor can be substantially homogenously dispersed in the resultant emulsion (i.e., the granola butter).

The additional fat can be any edible oil. In an embodiment, at least a portion of the additional fat at is at least one of vegetable oil or nut/seed oil. For example, at least a portion of the additional fat can be selected from the group consisting of olive oil, coconut oil, canola oil, avocado oil, butter, grapeseed oil, palm oil, sesame oil, safflower oil, rice bran oil, rapeseed oil, oil from one or more nuts such as almonds, oil from one or more legumes such as soybeans or peanuts, and mixtures thereof. In a particularly preferred embodiment, at least a portion of the additional fat is at least one of olive oil or coconut oil.

In an embodiment, the particle size of the granola can be reduced and/or the granola can be emulsified with the additional fat by subjecting the granola to one or more devices selected from the group consisting of a food processor such as a vertical food processor; a blender; a food processor such as a vertical food processor; a milling device such as a hammer mill, a spice mill, an oat mill, a stone mill, a roller mill, a ball mill; and a nut grinder. If the one or more inclusions or additives disclosed above are used, at least a portion thereof can be added to the granola before the granola is subjected to these one or more size reduction devices. Additionally or alternatively, at least a portion of the one or more inclusions or additives disclosed above can be mixed with the granola while the granola is subjected to these one or more size reduction devices.

In some embodiments, the amount of any oats in the granola butter is between about 20.0 wt. % and about 50.0 wt. %, preferably between about 25.0 wt. % and about 45.0 wt. %, more preferably between about 30.0 wt. % and about 40.0 wt. %, most preferably between about 34.0 wt. % and about 36.0 wt. %.

In some embodiments, the amount of any maple syrup in the granola butter is between about 5.0 wt. % and about 30.0 wt. %, preferably between about 10.0 wt. % and about 25.0 wt. %, more preferably between about 12.5 wt. % and about 20.0 wt. %, most preferably between about 15.0 wt. % and about 16.0 wt. %.

In some embodiments, the amount of any flax in the granola butter is between about 5.0 wt. % and about 35.0 wt. %, preferably between about 10.0 wt. % and about 30.0 wt. %, more preferably between about 15.0 wt. % and about 25.0 wt. %, most preferably between about 20.0 wt. % and about 21.0 wt. %.

In some embodiments, the total amount of the fat and the additional fat in the granola butter is between about 15.0 wt. % and about 35.0 wt. %, preferably between about 20.0 wt. % and about 30.0 wt. %, more preferably between about 22.5 wt. % and about 28.0 wt. %, most preferably between about 25.0 wt. % and about 27.0 wt. %. For example, the granola butter can contain olive oil in an amount between about 10.0 wt. % and about 25.0 wt. %, preferably between about 12.5 wt. % and about 22.5 wt. %, more preferably between about 15.0 wt. % and about 20.0 wt. %, most preferably between about 16.0 wt. % and about 18.0 wt. %; and/or coconut oil in an amount between about 1.0 wt. % and about 20.0 wt. %, preferably between about 2.5 wt. % and about 15.0 wt. %, more preferably between about 5.0 wt. % and about 12.0 wt. %, most preferably between about 8.0 wt. % and about 10.0 wt. %.

In a particularly preferred non-limiting embodiment, the process of making the granola butter comprises:

Baking Step:

Weigh the oats

Weigh the spices

Coat the oats in spices

Weigh olive oil and maple syrup

Combine olive oil and maple syrup with coated oats to form mixture

Portion mixture into lined sheet trays

Bake mixture in oven between about 260 and about 265° F. for about 35 minutes to form granola

Rotate and toss granola

Bake granola between about 260 and about 265° F. for about 35 minutes

Pull granola from oven

Let cool and place in airtight storage

Emulsification Step:

Load the toasted granola from the baking step, with flaxseeds into a vertical food processor

Blend dry ingredients to reduce particle size

Add fat (coconut oil & olive oil) to the dry mixture

Blend dry and wet ingredients, emulsifying them into a smooth creamy spread

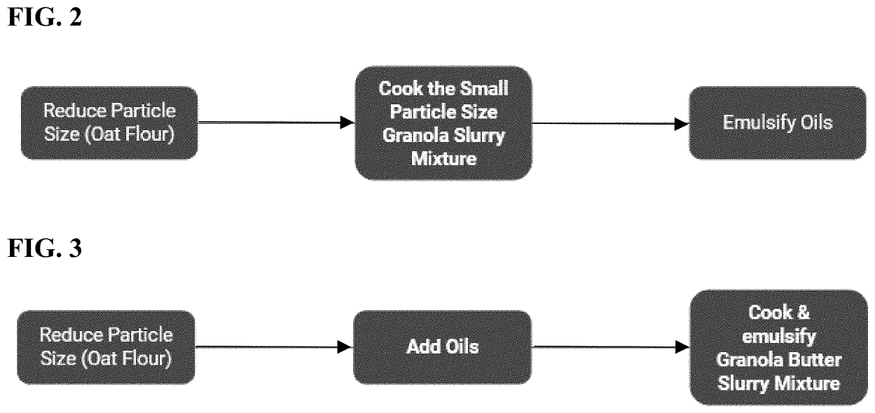

In some alternative embodiments of the process of making the granola butter (FIG. 2), a particle size of the oats (e.g., an oat flour) is reduced, and then the granola is formed by heating (e.g., cooking) a slurry comprising the reduced particle size oats optionally mixed with one or more of the other ingredients. Then the resultant granola is emulsified in the presence of the fat and/or the additional fat to form the spreadable granola butter. In other alternative embodiments of the process of making the granola butter (FIG. 3), a particle size of the oats (e.g., an oat flour) is reduced, and then the fat is added to the reduced particle size oats, and then the resultant slurry is heated (e.g., cooked) and emulsified to form the spreadable granola butter.

Preferably the food product disclosed herein (i.e., the spreadable granola butter) is packaged (Step 110) and then sold to a consumer. In an embodiment, a single serving of the food product is provided in a container such as a pouch. As used herein, the term “serving” refers to a predetermined quantity of the food product. In another embodiment, a plurality of servings can be provided in a single unitary composition that is preferably substantially homogeneous, and the consumer can separate the composition into one or more servings when desired. For example, the single composition comprising a plurality of servings can be provided in a container such as a jar. The jar can have a lid that the consumer can use to open the jar to allow the consumer to separate one or more servings of the food product from the remainder of the composition, and then the consumer can use the lid to close the jar.

In other embodiments, multiple servings of the food product can be individually packaged and provided to a consumer in a container. For example, a plurality of individually packaged food products (e.g., pouches that each contain a serving of the food product) can be provided to the consumer in a box that holds the plurality of the individually packaged food products, such as two, four, six, eight, ten or twelve individually packaged food products. Preferably the plurality of individually packaged food products are substantially the same predetermined quantity of the food product as each other.

### Examples

The following non-limiting examples generally illustrate embodiments of the compositions and methods disclosed herein.

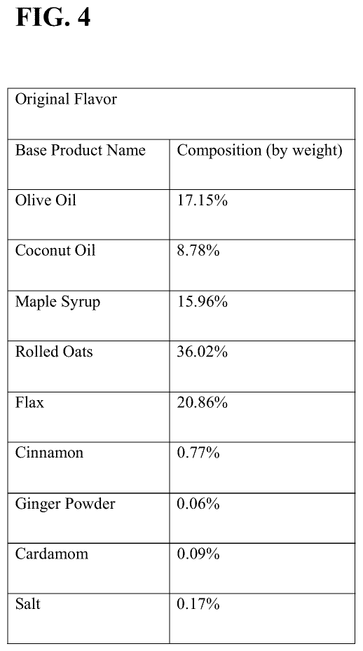

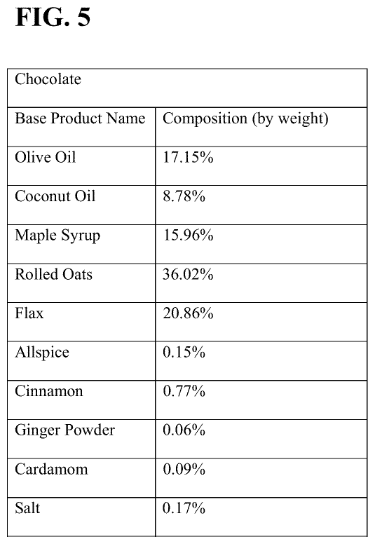

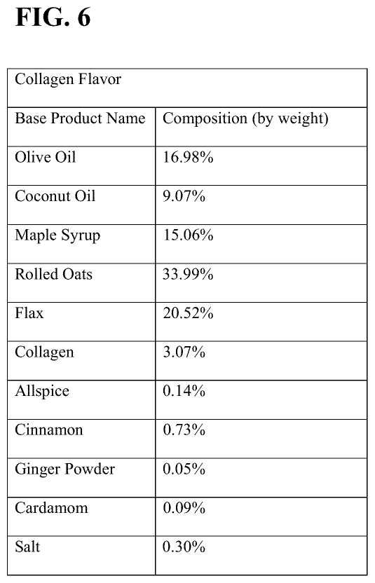

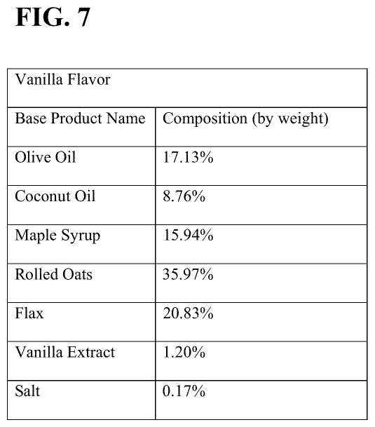

The table in FIG. 4 generally illustrates an embodiment of an original flavor spreadable granola butter. The table in FIG. 5 generally illustrates an embodiment of a chocolate flavor spreadable granola butter in which chocolate is baked into the granola before the emulsifying of the granola to disperse the chocolate throughout the granola butter. The table in FIG. 6 generally illustrates an embodiment of a collagen flavor spreadable granola butter in which collagen is added to the granola during and/or before the emulsifying of the granola to disperse the collagen throughout the granola butter. The table in FIG. 7 generally illustrates an embodiment of a vanilla flavor spreadable granola butter in which vanilla extract is added to the granola during and/or before the emulsifying of the granola to disperse the vanilla extract throughout the granola butter.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A spreadable granola butter comprising an emulsion of granola particles in an oil.

2. The spreadable granola butter of claim 1, wherein the granola particles comprise a cereal that has been subjected to milling.

3. The spreadable granola butter of claim 2, wherein the cereal comprises rolled oats that have been subjected to milling.

4. The spreadable granola butter of claim 1, wherein at least a portion of the oil is selected from the group consisting of olive oil, coconut oil, canola oil, avocado oil, butter, grapeseed oil, palm oil, sesame oil, safflower oil, rice bran oil, rapeseed oil, oil from one or more nuts, oil from one or more legumes, and mixtures thereof.

5. The spreadable granola butter of claim 1, having at least one characteristic selected from the group consisting of gluten-free; vegan; free of any genetically modified organisms (GMO's); and free of one or more of milk, eggs, fish, crustacean shellfish, tree nuts, peanuts, wheat or soya.

6. The spreadable granola butter of claim 1, wherein the emulsion further comprises a sweetener selected from the group consisting of maple syrup, honey, agave, brown sugar, regular sugar, dates, date sugar, molasses, fruit syrup, and mixtures thereof.

7. The spreadable granola butter of claim 1, wherein the granola particles are coated with at least one spice.

8. The spreadable granola butter of claim 7, wherein the at least one spice is selected from the group consisting of allspice, cinnamon, ginger, cardamom and mixtures thereof.

9. The spreadable granola butter of claim 1, further comprising at least one flavor.

10. The spreadable granola butter of claim 9, wherein the at least one flavor is selected from the group consisting of chocolate, vanilla extract, collagen, and combinations thereof; and the at least one flavor is included in the spreadable granola butter by at least one step selected from the group consisting of (i) mixing at least a portion of the at least one flavor with cereal that is then heated to form granola that is then milled to form the granola particles and (ii) mixing at least a portion of the at least one flavor with the granola particles that are then emulsifies to form the emulsion.

11. A method of making a granola butter from granola, the method comprising:
subjecting the granola to particle size reduction to form reduced size granola particles; and
emulsifying the granola in a fat to form the granola butter.

12. The method of claim 11, further comprising forming the granola before subjecting the granola to the particle size reduction, wherein the forming of the granola comprises heating a composition comprising a cereal and at least one of an oil or a sweetener.

13. The method of claim 12, wherein the heating of the composition comprising the cereal to form the granola is performed by at least one device selected from the group consisting of a convection oven, a tunnel oven, a conveyor oven, a heated mixer, a deck oven, and a walk-in oven.

14. The method of claim 12, wherein the cereal comprises rolled oats.

15. The method of claim 12, wherein the forming of the granola comprises forming the composition before and/or during the heating of the composition, wherein the forming of the composition comprises mixing the cereal with at least one additional ingredient selected from the group consisting of salt, a spice, flaxseed, an oil, a sweetener and mixtures thereof.

16. The method of claim 15, wherein the mixing of the cereal with the at least one additional ingredient before and/or during the heating of the composition is performed by at least one device selected from the group consisting of a tank mixer, a vat mixer, an agitator, a bowl mixer, and a bar mixer.

17. The method of claim 11, wherein at least one of the particle size reduction of the granola or the emulsifying of the granola is performed in at least one machine selected from the group consisting of a blender, a vertical food processor, a hammer mill, a spice mill, an oat mill, a stone mill, a roller mill, a ball mill, a nut grinder, a vat mixer and a tumbler mixer.

18. The method of claim 11, wherein at least a portion of the particle size reduction of the granola is performed at a different time than the emulsifying of the granola.

19. The method of claim 11, wherein at least a portion of the particle size reduction of the granola is performed concurrently with at least a portion of the emulsifying of the granola.

20. A method of providing nutrition to a human, the method comprising orally administering a granola butter to the human, the granola butter comprising an emulsion of granola particles in an oil.

21. The method of claim 20, wherein the human has an allergy to at least one allergen selected from the group consisting of gluten, milk, eggs, fish, crustacean shellfish, tree nuts, peanuts, wheat, soya and combinations thereof and the at least one allergen is absent from the granola butter.

22. The method of claim 20, wherein the administering of the granola butter to the human comprises spreading the granola butter on another food product.
